(19) United States
(12) Patent Application Publication
(10) Pub. No.: US 2026/0009953 A1
(43) Pub. Date: Jan. 8, 2026

(54) CABLE-END CONNECTOR OF OPTICAL-FIBER CONNECTOR ASSEMBLY

(71) Applicant: ADVANCED-CONNECTEK INC., New Taipei City (TW)

(72) Inventors: Sheng-Hsiang Huang, New Taipei City (TW); Shu-Fen Wang, New Taipei City (TW); Hou-Bin Lin, New Taipei City (TW); Kuan-Lin Chen, New Taipei City (TW); Ta-Teh Meng, New Taipei City (TW)

(21) Appl. No.: 19/259,965

(22) Filed: Jul. 3, 2025

Related U.S. Application Data
(60) Provisional application No. 63/667,907, filed on Jul. 5, 2024.

(51) Int. Cl. G02B 6/38

(52) U.S. Cl. CPC G02B 6/3885; G02B 6/3881

(57) ABSTRACT

A cable-end connector of an optical-fiber connector assembly includes a cable-end shell, an insulating housing, a first terminal module, a second terminal module, and a cable-end optical communication module. The cable-end shell has an accommodation groove. The insulating housing is in the accommodation groove and includes a first plate and a second plate which are opposite to each other, two insertion grooves between the first plate and the second plate, and a mating opening in communication with the insertion grooves. The first terminal module is arranged at one end of the insulating housing away from the mating opening. The first and second terminal modules respectively include first and a second terminal bases as well as first and second plug power terminals. One end of each of the first or second plug power terminals extend toward the two sides of the insertion grooves from the first or second plates.

### CROSS-REFERENCE TO RELATED APPLICATION

This application claims the benefit of U.S. provisional application Ser. No. 63/667,907, filed on Jul. 5, 2024, the entire contents of which are hereby incorporated by reference.

### FIELD OF THE INVENTION

The instant disclosure relates to a connector assembly, and more particular to an optical-fiber connector assembly.

### BACKGROUND

As known to the inventor, connectors conduct electrical signal transmission by taking copper as the conductive material; however, as the transmission speed increases, the connectors suffer more interferences caused by external signals and environments. The transmission speed by taking copper as the conductive material almost reaches the bottleneck, and developments of the connector have to be conducted using optical-fiber connector assembly which adopts light as the medium. Moreover, signal transmission and power transmission by using copper as the conductive material may interfere each other easily, and the integrity for signal and power would need to be properly organized. Though using optical-fiber connector assembly can increase the signal transmission speed, effective and sufficient power supply cannot be achieved.

### SUMMARY OF THE INVENTION

According to some embodiments, an optical-fiber connector assembly is provided and comprises a cable-end connector. The cable-end connector comprises a cable-end shell, an insulating housing, a first terminal module, a second terminal module, and a cable-end optical communication module. The cable-end shell has an accommodation groove. The insulating housing is in the accommodation groove, and the insulating housing comprises a first plate and a second plate which are opposite to each other, two insertion grooves between the first plate and the second plate, and a mating opening in communication with the insertion grooves. The first terminal module is arranged at one of two ends of the insulating housing away from the mating opening. The first terminal module comprises a first terminal base and a plurality of first plug power terminals retained in the first terminal base. One of two ends of each of the first plug power terminals extends toward one of two sides of a corresponding one of the insertion grooves from the first plate. The second terminal module is arranged at the end of the insulating housing away from the mating opening. The second terminal module comprises a second terminal base and a plurality of second plug power terminals retained in the second terminal base. One of two ends of each of the second plug power terminals extends toward the other side of the corresponding one of the insertion grooves from the second plate. The second terminal base is assembled with the first terminal base. The cable-end optical communication module is in the mating opening and between the insertion grooves.

In some embodiments, the first plug power terminals comprise a plurality of first-row flexible contact portions, and the first-row flexible contact portions are at two sides of the cable-end optical communication module. The second plug power terminals comprise a plurality of second-row flexible contact portions, and the second-row flexible contact portions are at the two sides of the cable-end optical communication module. Each of the first-row flexible contact portions defines a first axial line extending toward second plate. Each of the second-row flexible contact portions defines a second axial line extending toward the first plate. Each of the first axial lines is offset from a corresponding one of the second axial lines.

In some embodiments, the number of the first plug power terminals on the first plate is four or more and the number of the second plug power terminals on the second plate is four or more. The first plug power terminals comprise four or more of the first-row flexible contact portions at the two sides of the cable-end optical communication module, and the second plug power terminals comprise four or more of the second-row flexible contact portions at the two sides of the cable-end optical communication module.

In some embodiments, the cable-end shell has two long side walls opposite to each other and two short side walls opposite to each other, two sides of each of the short side walls are connected to the two long side walls, and a chamfer angle is at a corner between at least one of the short side walls and a corresponding one of the long side walls.

In some embodiments, the cable-end optical communication module comprises a lens. The lens has a mating surface facing the mating opening, a recessed portion at the mating surface, and a plurality of contacts in the recessed portion.

In some embodiments, the number of the contacts is twelve or more, and the contacts are arranged as two rows.

In some embodiments, the cable-end optical communication module comprises two guiding portions at the two sides of the mating surface and a plurality of elastic members at one of two ends of the lens away from the guiding portions, and two ends of each of the elastic members abut against the lens and the insulating housing.

In some embodiments, an optical-fiber connector assembly is provided and comprises a cable-end connector. The cable-end connector comprises a cable-end shell, an insulating housing, a first terminal module, a second terminal module, and a cable-end optical communication module. The cable-end shell has an accommodation groove. The insulating housing is in the accommodation groove, and the insulating housing comprises a first plate and a second plate which are opposite to each other, an insertion groove between the first plate and the second plate, and a mating opening in communication with the insertion groove. The first terminal module is arranged at one of two ends of the insulating housing away from the mating opening. The first terminal module comprises a first terminal base and a plurality of first plug power terminals retained in the first terminal base. One of two ends of each of the first plug power terminals extends toward one of two sides of the insertion groove from the first plate. The second terminal module is arranged at the end of the insulating housing away from the mating opening. The second terminal module comprises a second terminal base and a plurality of second plug power terminals retained in the second terminal base. One of two ends of each of the second plug power terminals extends toward the other side of the insertion groove from the second plate. The second terminal base is assembled with the first terminal base. The cable-end optical communication module is in the mating opening and at a side portion of the insertion groove.

In some embodiments, the first plug power terminals comprise a plurality of first-row flexible contact portions, and the first-row flexible contact portions are at a side portion of the cable-end optical communication module. The second plug power terminals comprise a plurality of second-row flexible contact portions, and the second-row flexible contact portions are at the side portion of the cable-end optical communication module and adjacent to the first-row flexible contact portions. Each of the first-row flexible contact portions defines a first axial line extending toward the second plate, each of the second-row flexible contact portions defines a second axial line extending toward the first plate, and each of the first axial lines is offset from a corresponding one of the second axial lines.

In some embodiments, the number of the first plug power terminals on the first plate is three or more, the number of the second plug power terminals on the second plate is three or more, the first plug power terminals comprise three of the first-row flexible contact portions at the side portion of the cable-end optical communication module, and the second plug power terminals comprise three of the second-row flexible contact portions at the side portion of the cable-end optical communication module.

As above, according to some embodiments, the insulating housing in the cable-end shell comprises the first plate and the second plate which are opposite to each other and the two insertion grooves between the first plate and the second plate, the first plug power terminals of the first terminal module and the second plug power terminals of the second terminal module base extend toward the insertion grooves from the first plate and the second plate. Therefore, the cable-end connector for an optical-fiber connector assembly can be provided. Moreover, the number of the plug power terminals of the cable-end connector can be adjusted according to different demands.

Detailed description of the characteristics and the advantages of the instant disclosure are shown in the following embodiments. The technical content and the implementation of the instant disclosure should be readily apparent to any person skilled in the art from the detailed description, and the purposes and the advantages of the instant disclosure should be readily understood by any person skilled in the art with reference to content, claims, and drawings in the instant disclosure.

### BRIEF DESCRIPTION OF THE DRAWINGS

The instant disclosure will become more fully understood from the detailed description given herein below for illustration only, and thus not limitative of the instant disclosure, wherein:

FIG. 1 illustrates a perspective view of a board-end connector and a cable-end connector of an optical-fiber connector assembly according to some embodiments of the instant disclosure;

FIG. 2 illustrates an exploded view of the board-end connector according to some embodiments of the instant disclosure taken from an oblique top-plan view;

FIG. 3 illustrates an exploded view of the board-end connector according to some embodiments of the instant disclosure taken from an oblique bottom-plan view;

FIG. 4 illustrates a perspective view of the board-end connector in a semi-assembled state according to some embodiments of the instant disclosure;

FIG. 5 illustrates an exploded view of the cable-end connector according to some embodiments of the instant disclosure taken from an oblique top-plan view;

FIG. 6 illustrates an exploded view of the cable-end connector according to some embodiments of the instant disclosure taken from an oblique bottom-plan view;

FIG. 7 illustrates a perspective view of the cable-end connector in a semi-assembled state according to some embodiments of the instant disclosure;

FIG. 8 illustrates a top cross-sectional view of the board-end connector and the cable-end connector according to some embodiments, where the board-end connector and the cable-end connector are not mated with each other yet;

FIG. 9 illustrates a top cross-sectional view of the board-end connector and the cable-end connector according to some embodiments, where the board-end connector and the cable-end connector are mated with each other;

FIG. 10 illustrates a side cross-sectional view of the board-end connector and the cable-end connector according to some embodiments, where the board-end connector and the cable-end connector are not mated with each other yet;

FIG. 11 illustrates a top cross-sectional view of the board-end connector and the cable-end connector according to some embodiments, where the board-end connector and the cable-end connector are mated with each other;

FIG. 12 illustrates a cross-sectional view along line 12-12 shown in FIG. 11;

FIG. 13 illustrates a cross-sectional view according to the viewing angle of FIG. 12;

FIG. 14 illustrates a perspective view of a board-end connector and a cable-end connector of an optical-fiber connector assembly according to some embodiments of the instant disclosure;

FIG. 15 illustrates an exploded view of the board-end connector according to some embodiments of the instant disclosure taken from an oblique top-plan view;

FIG. 16 illustrates an exploded view of the board-end connector according to some embodiments of the instant disclosure taken from an oblique bottom-plan view;

FIG. 17 illustrates a cross-sectional view according to the viewing angle of FIG. 12;

FIG. 18 illustrates a perspective view of a board-end connector and a cable-end connector of an optical-fiber connector assembly according to some embodiments of the instant disclosure; and

FIG. 19 illustrates a cross-sectional view according to the viewing angle of FIG. 12.

### DETAILED DESCRIPTION

Hereinafter, terms regarding “connect” may be directed to physical connection or may be directed to direct or indirect connection between physical components. To illustrate the embodiments more clearly, in the drawings, the first axis X is the X axis of the three-dimensional coordinate system, the second axis Y is the Y axis of the three-dimensional coordinate system, and the third axis Z is the Z axis of the three-dimensional coordinate system.

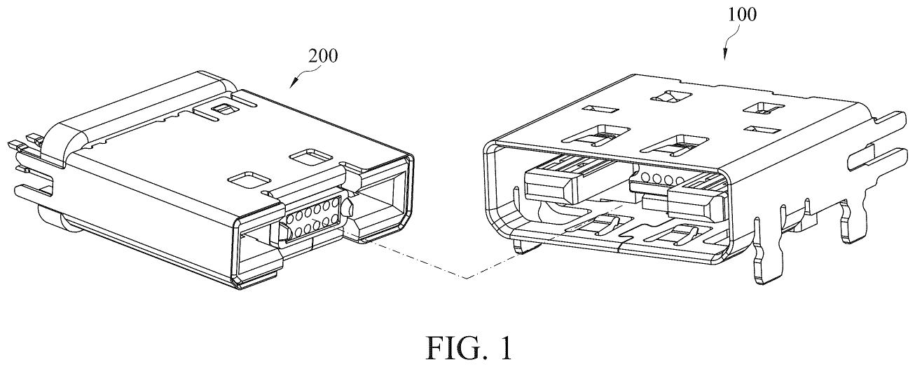

Please refer to FIG. 1. FIG. 1 illustrates a perspective view of a board-end connector 100 and a cable-end connector 200 of an optical-fiber connector assembly. The optical-fiber connector assembly comprises a board-end connector 100 and a cable-end connector 200. The optical-fiber connector assembly has a compact factor, with a size approximately equal to the size of a USB Type-C connector. The optical-fiber connector assembly is configured to be utilized for various consumer electronics or wearable devices.

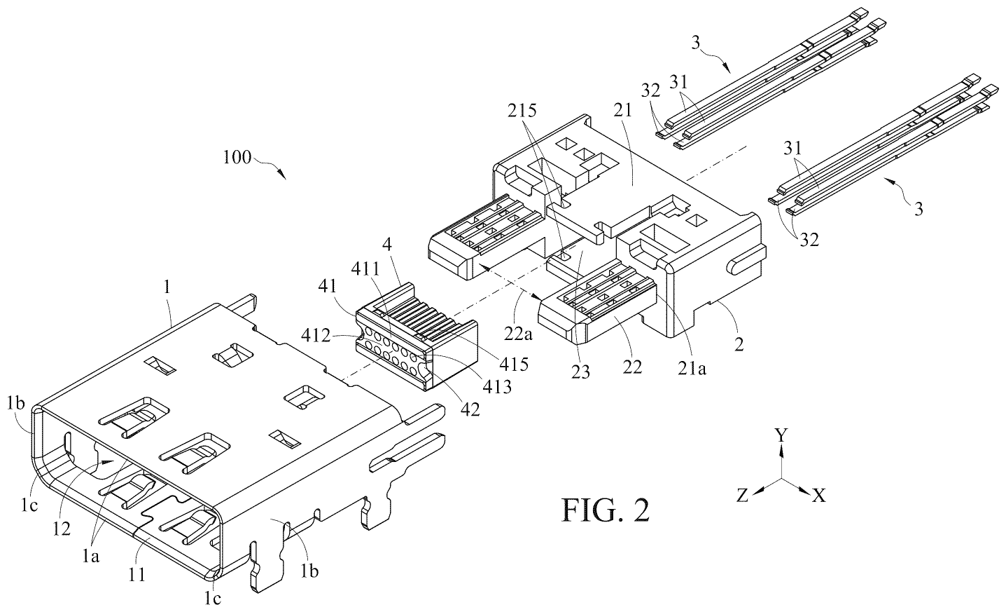

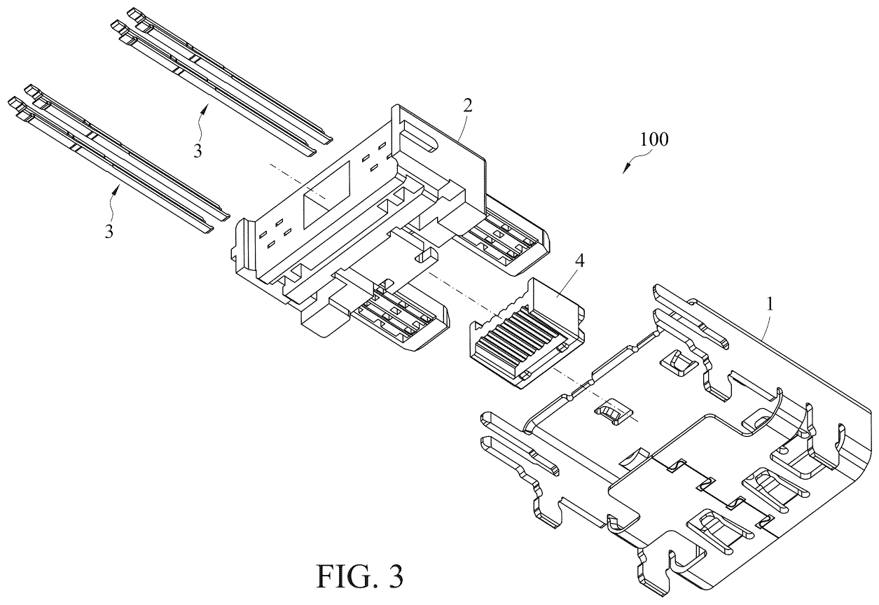

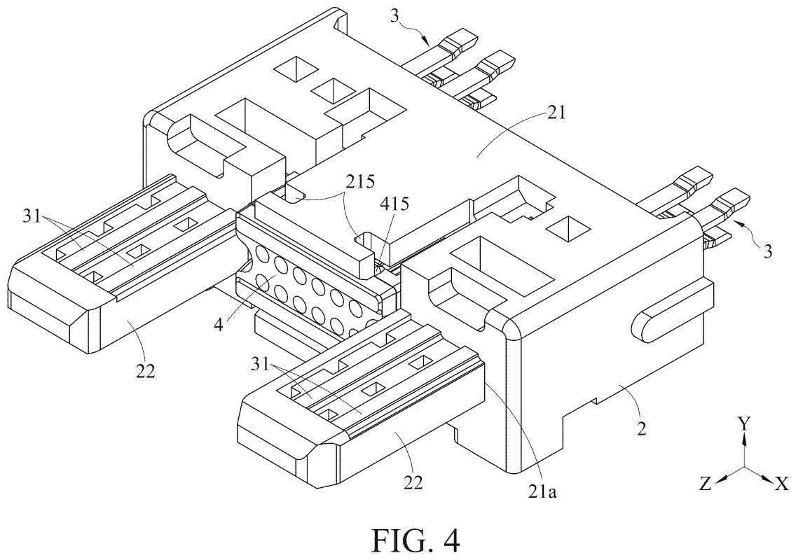

Please refer to FIG. 2 to FIG. 4. FIG. 2 illustrates an exploded view of the board-end connector 100 taken from an oblique top-plan view. FIG. 3 illustrates an exploded view of the board-end connector 100 from an oblique bottom-plan view. FIG. 4 illustrates a perspective view of the board-end connector 100 in a semi-assembled state. The board-end connector 100 comprises a board-end shell 1, an insulating housing 2, a plurality of receptacle power terminals 3, and a board-end optical communication module 4. The board-end shell 1 defines an insertion opening 11 and an accommodation space 12 located within the insertion opening 11. The insulating housing 2 is in the accommodation space 12. The insulating housing 2 comprises a base portion 21 and tongue portions 22. The tongue portions 22 extend outward from a side surface of the base portion 21, and the insulating housing 2 comprises an assembling portion 23 which is defined through the base portion 21 and adjacent to the tongue portions 22. The receptacle power terminals 3 are retained in the base portion 21. One end of each of the receptacle power terminals 3 is exposed from two faces of a corresponding one of the tongue portions 22. The board-end optical communication module 4 is located inside the assembling portion 23. The other ends of the receptacle power terminals 3 are exposed from the base portion 21 and configured to be connected to a circuit board. The board-end optical communication module 4 is configured to be connected to an optical-fiber core wire.

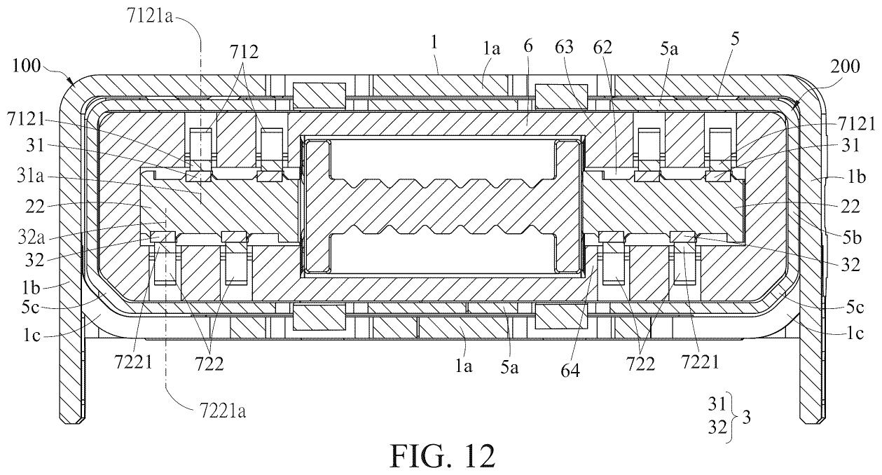

Please refer to FIG. 2 to FIG. 4. In some embodiments, the receptacle power terminals 3 comprise a plurality of first receptacle power terminals 3 (upper-row terminals) and a plurality of second receptacle power terminals 3 (lower-row terminals). The upper-row terminals are four flat terminals, and the lower-row terminals are also four flat terminals. The first receptacle power terminals 3 comprise four or more first-row flat contact portions 31, and each of which is located at one face of the two faces of each of the tongue portions 22. The second receptacle power terminals 3 comprise four or more second-row flat contact portions 32, and each of which is located at the opposite face of each of the tongue portions 22. Each of the first-row flat contact portions 31 defines a first axial line 31a extending from the opposite face of each of the tongue portions 22 (as shown in FIG. 12), and each of the second-row flat contact portions 32 defines a second axial line 32a extending from the face of each of the tongue portions 22. For each of the tongue portions 22, each of the first axial lines 31a is offset from a corresponding one of the second axial lines 32a, so that the upper terminals and the lower terminals are arranged in a staggered configuration. Therefore, the combination of the insulating housing 2 and the receptacle power terminals 3 can be achieved via one-time injection molding.

Please refer to FIG. 2 to FIG. 4. In some embodiments, the tongue portions 22 are arranged corresponding to a middle portion 21a at the side surface of the base portion 21; that is, in some embodiments, each of the tongue portions 22 is at the middle portion 21a between the top surface and the bottom surface of the base portion 21 along the second axis (Y direction). Moreover, the tongue portions 22 are arranged side-by-side along the first axis (X direction), and a pitch 22a is defined between the adjacent tongue portions 22. Moreover, the insulating housing 2 has a plurality of engaging grooves 215 at the base portion 21 and between the tongue portions 22.

Please refer to FIG. 2 to FIG. 4. In some embodiments, the board-end shell 1 has two long side walls 1a opposite to each other and two short side walls 1b opposite to each other, two sides of each of the short side walls 1b are connected to the two long side walls 1a, and a chamfer angle 1c is provided at a corner between at least one of the short side walls 1b and a corresponding one of the long side walls 1a. As shown in FIG. 1 and FIG. 12, the chamfer angles 1c of the board-end shell 1 is between a bottom portion of the at least one of the short side walls 1b and each of two sides of the corresponding one of the long side walls 1a, but the instant disclosure is not limited thereto; in some embodiments, the chamfer angle 1c is between a top portion of the at least one of the short side walls 1b and each of two sides of the corresponding one of the long side walls 1a.

Please refer to FIG. 2 to FIG. 4. In some embodiments, the board-end optical communication module 4 comprises a lens 41. The lens 41 has a mating surface 411 facing the insertion opening 11, a recessed portion 412 at the mating surface 411, and a plurality of contacts 413 in the recessed portion 412. The number of the contacts 413 is twelve or more (e.g., sixteen or twenty); the contacts 413 are arranged as two rows along the second axis Y direction, so that the contacts 413 are configured as a double-row arrangement. The overall width of the board-end connector 100 may vary depending on the change of the number of the contacts 413; that is, in some embodiments, the greater the number of the contacts 413, the wider the overall width of the board-end connector 100.

Please refer to FIG. 2 to FIG. 4. In some embodiments, the board-end optical communication module 4 comprises two guiding portions 42 at the two sides of the mating surface 411. The guiding portion 42 is a recessed groove (cone shaped), and the diameter of the recessed groove gradually decreases from the opening to the bottom. Moreover, the lens 41 comprises a plurality of engaging blocks 415 at the two sides of the mating surface 411. When the board-end optical communication module 4 is assembled onto the assembling portion 23 of the insulating housing 2, each of the engaging blocks 415 is engaged with a corresponding one of the engaging grooves 215.

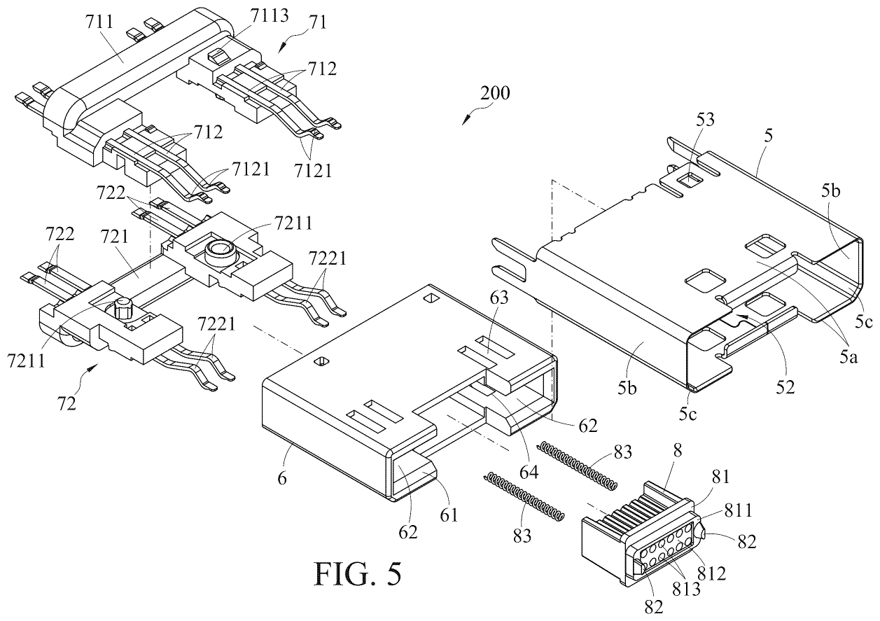

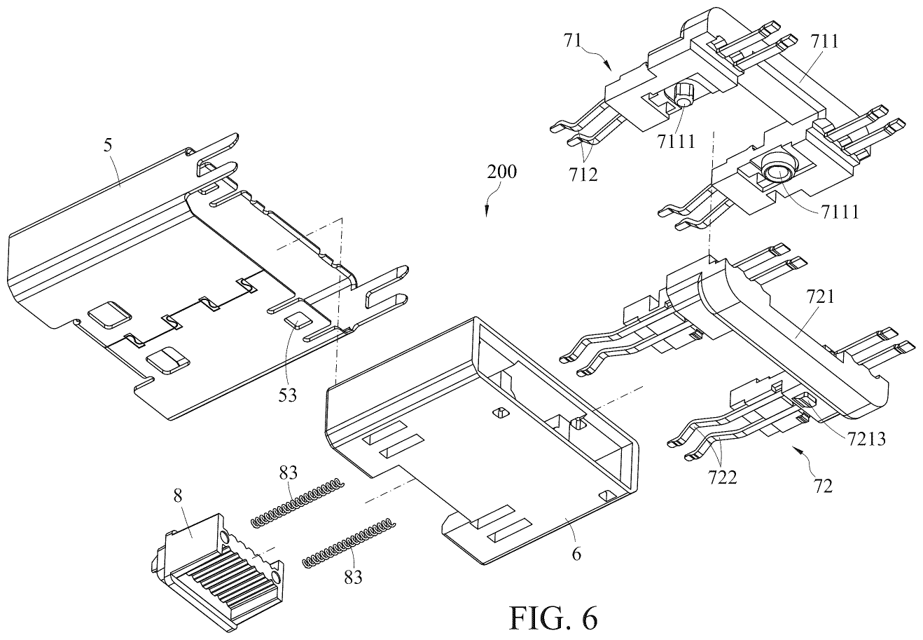

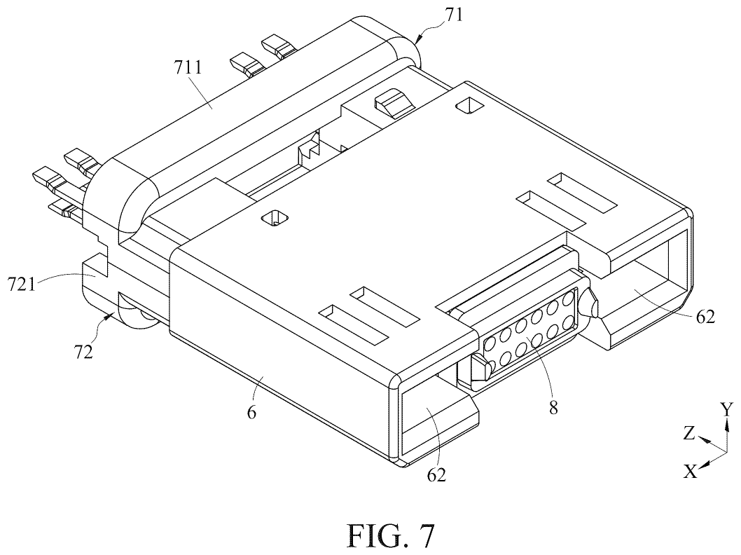

Please refer to FIG. 5 to FIG. 7. FIG. 5 illustrates an exploded view of the cable-end connector 200 taken from an oblique top-plan view. FIG. 6 illustrates an exploded view of the cable-end connector 200 taken from an oblique bottom-plan view. FIG. 7 illustrates a perspective view of the cable-end connector 200 in a semi-assembled state. The cable-end connector 200 comprises a cable-end shell 5, an insulating housing 6, a first terminal module 71, a second terminal module 72, and a cable-end optical communication module 8. The cable-end shell 5 defines an accommodation groove 52. The insulating housing 6 is disposed in the accommodation groove 52. The insulating housing 6 comprises a first plate 63 and a second plate 64 which are opposite to each other, two insertion grooves 62 between the first plate 63 and the second plate 64, and a mating opening 61 in communication with the insertion grooves 62. The first terminal module 71 comprises a first terminal base 711 and a plurality of plug power terminals 712 retained in the first terminal base 711. When the first terminal module 71 is assembled on the insulating housing 6, one of two ends of each of the first plug power terminals 712 extends toward one of two sides of a corresponding one of the insertion grooves 62 from the first plate 63.

Please refer to FIG. 5 to FIG. 7. The second terminal module 72 comprises a second terminal base 721 and a plurality of second plug power terminals 722 retained in the second terminal base 721. When the second terminal module 72 is assembled on the insulating housing 6, one of two ends of each of the second plug power terminals 722 extends toward the other side of the corresponding one of the insertion grooves 62 from the second plate 64. Moreover, the cable-end optical communication module 8 is disposed within the mating opening 61 and between the insertion grooves 62. The other end of each of the first plug power terminals 712 is exposed from the first terminal base 711 and configured to be connected to a circuit board, the other end of each of the second plug power terminals 722 is exposed from the second terminal base 721 and configured to be connected to the circuit board, and the cable-end optical communication module 8 is configured to be connected to an optical-fiber core wire.

After the second terminal base 721 is assembled with the first terminal base 711, the first terminal module 71 and the second terminal module 72 are assembled on the insulating housing 6, so that the first terminal module 71 is arranged at one of two ends of the insulating housing 6 away from the mating opening 61, and the second terminal module 72 is also arranged at the end of the insulating housing 6 away from the mating opening 61.

Please refer to FIG. 5 to FIG. 7. In some embodiments, the first plug power terminals 712 comprise four first-row flexible contact portions 7121, and the first-row flexible contact portions 7121 are positioned at two sides of the cable-end optical communication module 8; the second plug power terminals 722 comprise four second-row flexible contact portions 7221, and the second-row flexible contact portions 7221 are at the two sides of the cable-end optical communication module 8. Each of the first-row flexible contact portions 7121 defines a first axial line 7121a extending toward the second plate 64 (as shown in FIG. 12), each of the second-row flexible contact portions 7221 defines a second axial line 7221a extending toward the first plate 63 (as shown in FIG. 12), and each of the first axial lines 7121a is offset from a corresponding one of the second axial lines 7221a. Please refer to FIG. 12. The first axial line 7121a of the first-row flexible contact portion 7121 is aligned with the first axial line 31a of the first-row flat contact portion 31, and the second axial line 7221a of the second-row flexible contact portion 7221 is aligned with the second axial line 32a of the second-row flat contact portion 32.

Please refer to FIG. 5 to FIG. 7. In some embodiments, the number of the first plug power terminals 712 at the first plate 63 is four or more, and the number of the second plug power terminals 722 at the second plate 64 is also four or more. The first plug power terminals 712 comprise four or more of the first-row flexible contact portions 7121 at the two sides of the cable-end optical communication module 8, and the second plug power terminals 722 comprise four or more of the second-row flexible contact portions 7221 at the two sides of the cable-end optical communication module 8.

Please refer to FIG. 5 to FIG. 7. In some embodiments, the cable-end shell 5 has two long side walls 5a opposite to each other and two short side walls 5b opposite to each other, two sides of each of the short side walls 5b are connected to the two long side walls 5a, and a chamfer angle 5c is provided at a corner between at least one of the short side walls 5b and a corresponding one of the long side walls 5a. As shown in FIG. 5 and FIG. 12, the chamfer angle 5c of the cable-end shell 5 is between a bottom portion of the at least one of the short side walls 5b and each of two sides of the corresponding one of the long side walls 5a, but the instant disclosure is not limited thereto; in some embodiments, the chamfer angle 5c is between a top portion of the at least one of the short side walls 5b and each of two sides of the corresponding one of the long side walls 5a.

Please refer to FIG. 5 to FIG. 7. In some embodiments, the cable-end optical communication module 8 comprises a lens 81. The lens 81 has a mating surface 811 facing the mating opening 61, a recessed portion 812 at the mating surface 811, and a plurality of contacts 813 disposed within the recessed portion 812. One end of the lens 81 away from the mating surface 811 has a cavity configured for the connection of optical-fibers. Moreover, the number of the contacts 813 is twelve or more (e.g., sixteen or twenty); the contacts 813 are arranged as two rows, so that the contacts 813 are configured as a double-row arrangement. The overall width of the cable-end connector 200 may vary depending on the change of the number of the contacts 813; that is, in some embodiments, the greater the number of the contacts 813, the wider the overall width of the cable-end connector 200.

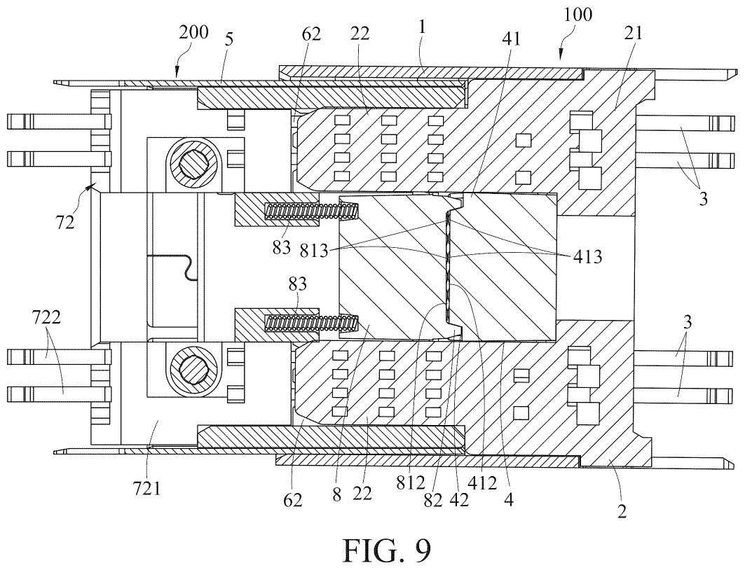

Please refer to FIG. 5 to FIG. 7. In some embodiments, the cable-end optical communication module 8 comprises two guiding portions 82 and a plurality of elastic members 83 at the two sides of the mating surface 811. The guiding portion 82 is a protruding post (cone shaped), and the elastic members 83 are at one of two ends of the lens 81 away from the guiding portions 82. Two ends of each of the elastic members 83 abut against between the lens 81 and the insulating housing 6. One of two ends of the lens 81 is abutted against by the elastic member 83, so that an operation space 810 is between the lens 81 and the inner wall of the mating opening 61; the other end of the lens 81 leans against the cable-end shell 5. When the board-end connector 100 is mated with the cable-end connector 200, the board-end optical communication module 4 and the cable-end optical communication module 8 are precisely positioned with each other, the guiding portions 82 and the guiding portions 42 are guided and mated with each other, a gap is between the board-end connector 100 and the cable-end connector 200 (as shown in FIG. 9), and the gap is between the recessed portion 412 of the board-end optical communication module 4 and the recessed portion 812 of the cable-end optical communication module 8. Therefore, the contacts 413 of the board-end optical communication module 4 are mated with the contacts 813 of the cable-end optical communication module 8.

Please refer to FIG. 5 and FIG. 6. In some embodiments, the first terminal base 711 of the cable-end connector 200 has a plurality of first fixing structures 7111, the second terminal base 721 of the cable-end connector 200 has a plurality of second fixing structures 7211, the first fixing structures 7111 are protruding blocks and engaging holes, and the second fixing structures 7211 are protruding blocks and engaging holes. When the first terminal base 711 and the second terminal base 721 are to be assembled with each other, the protruding blocks and the engaging holes of the first fixing structures 7111 are engaged with the protruding blocks and the engaging holes of the second fixing structures 7211, so that the first terminal base 721 and the second terminal base 711 are assembled with each other.

Please refer to FIG. 5 and FIG. 6. In some embodiments, the first terminal base 711 of the cable-end connector 200 comprises a first protruding engaging structure 7113, the second terminal base 721 of the cable-end connector 200 comprises a second protruding engaging structure 7213, and two faces of the cable-end shell 5 comprise recessed engaging structures 53. When the first terminal base 711 and the second terminal base 721 are assembled in the cable-end shell 5, the first protruding buckling structure 7113 and the second protruding buckling structure 7213 are engaged with the recessed engaging structures 53.

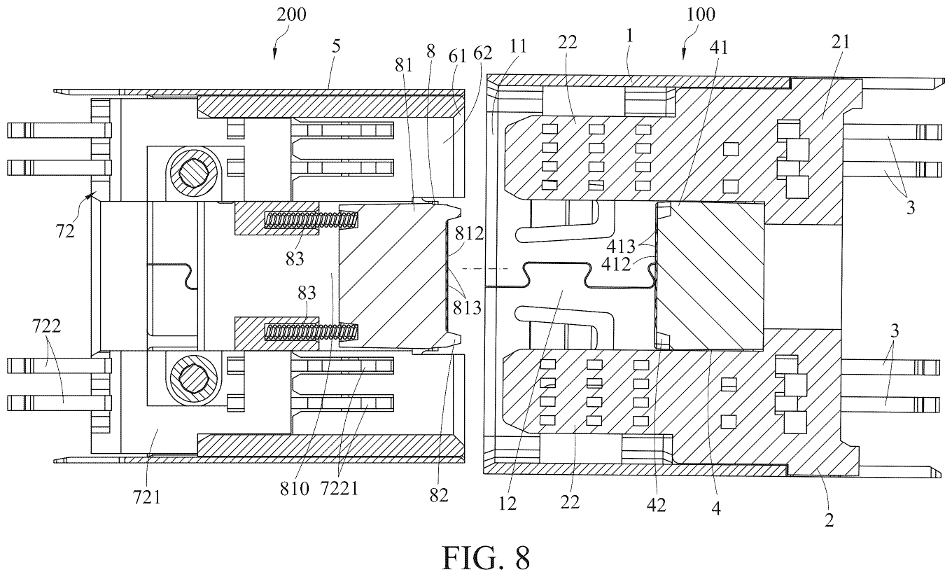

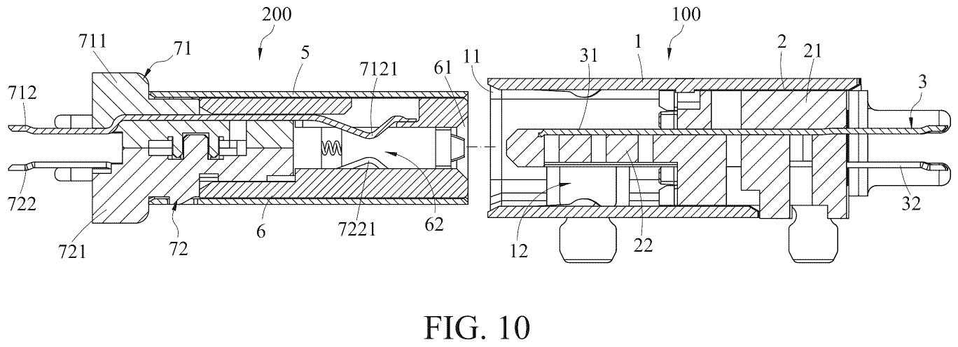

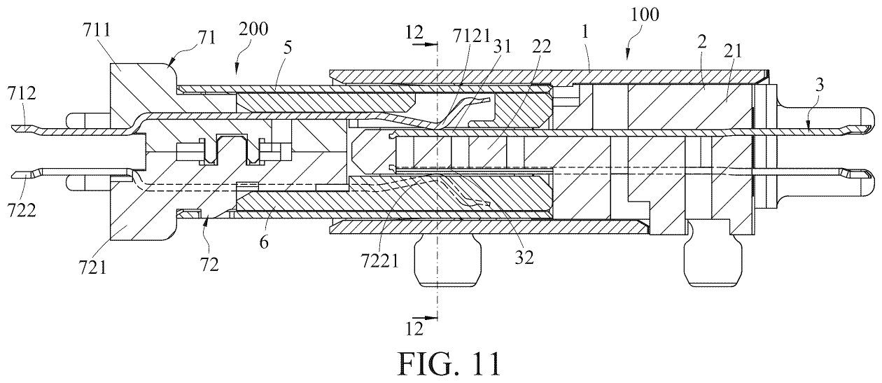

Please refer to FIG. 8 to FIG. 12. FIG. 8 illustrates a top cross-sectional view of the board-end connector 100 and the cable-end connector 200, where the board-end connector 100 and the cable-end connector 200 are not mated with each other yet. FIG. 9 illustrates a top cross-sectional view of the board-end connector 100 and the cable-end connector 200, where the board-end connector 100 and the cable-end connector 200 are mated with each other. FIG. 10 illustrates a side cross-sectional view of the board-end connector 100 and the cable-end connector 200, where the board-end connector 100 and the cable-end connector 200 are not mated with each other yet. FIG. 11 illustrates a side cross-sectional view of the board-end connector 100 and the cable-end connector 200, where the board-end connector 100 and the cable-end connector 200 are mated with each other. FIG. 12 illustrates a cross-sectional view along line 12-12 shown in FIG. 11. When the cable-end connector 200 is mated with the board-end connector 100, the cable-end shell 5 is inserted into the accommodation space 12 through the insertion opening 11 of the board-end shell 1, and the two tongue portions 22 are respectively inserted into the two insertion grooves 62, so that the cable-end connector 200 and the board-end connector 100 can be mated with each other. Next, the first-row flexible contact portions 7121 of the first plug power terminals 712 contact the first-row flat contact portions 31, and the second-row flexible contact portions 7221 of the second plug power terminals 722 contact the second-row flat contact portions 32. Then, the board-end optical communication module 4 is mated with the cable-end optical communication module 8, so that signals can be transmitted through the optical-fiber wires connected to the board-end optical communication module 4 and the optical-fiber wires connected to the cable-end optical communication module 8.

Please refer to FIG. 12. The chamfer angle 1c of the board-end shell 1 corresponds to the chamfer angle 5c of the cable-end shell 5. When the cable-end connector 200 is mated with the board-end connector 100, the chamfer angle 1c of the board-end shell 1 is correspondingly mated with the chamfer angle 5c of the cable-end shell 5 to provide a mistake proof function for the mating, so that the cable-end connector 200 can be mated with the board-end connector 100 with the front orientation, but the instant disclosure is not limited thereto.

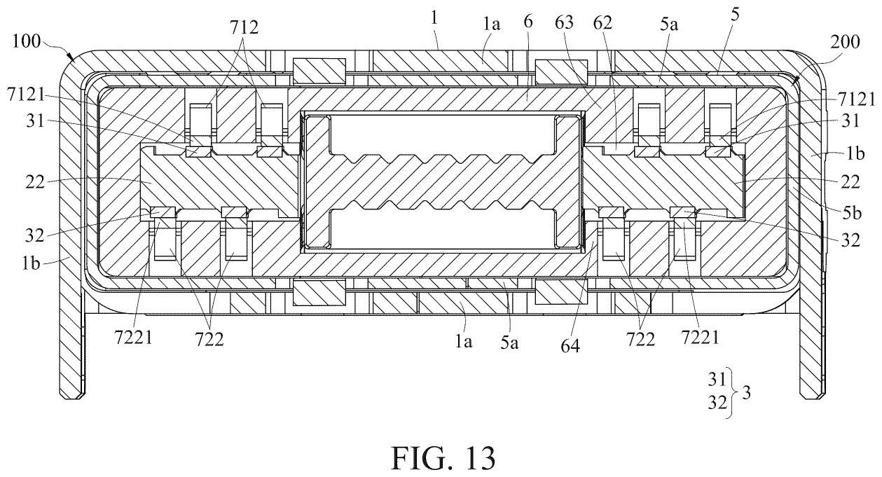

Please refer to FIG. 13. FIG. 13 illustrates a cross-sectional view according to the viewing angle of FIG. 12. In some embodiments, the corners at the two sides of the board-end shell 1 may be devoid of the chamfer angle 1c, and the corners at the two sides of the cable-end shell 5 may be devoid of the chamfer angle 5c; that is, in some embodiments, the corners between the long side wall 1a and the short side wall 1b of the board-end shell 1 do not have the chamfer angle 1c, the corners between the long side wall 5a and the short side wall 5b of the cable-end shell 5 do not have the chamfer angle 5c, and the outline of the board-end shell 1 corresponds to the outline of the cable-end shell 5. When the cable-end connector 200 is mated with the board-end connector 100, the pin-assignments of the receptacle power terminals 3 are 180 degree symmetrical, dual or double orientation design which enable the cable-end connector 200 to be inserted into the board-end connector 100 in either of two intuitive orientations, i.e., in either upside-up or upside-down directions. In other words, in some embodiments, the pin-assignments of the receptacle power terminals 3 have 180 degree symmetrical, dual or double orientation design with respect to a central point of the accommodation space 12 (as shown in FIG. 2) as the symmetrical center. Here, point-symmetry refers to that after the receptacle power terminals 3 at the upper row (or the receptacle power terminals 3 at the lower row), are rotated by 180 degrees with the symmetrical center as the rotating center, the receptacle power terminals 3 at the upper row and the receptacle power terminals 3 at the lower row are aligned; that is, the rotated upper-row receptacle power terminals 3 are arranged at the original position of the lower-row receptacle power terminals 3, and the rotated lower-row receptacle power terminals 3 are arranged at the original position of the upper-row receptacle power terminals 3. Consequently, the cable-end connector 200 is inserted into the board-end connector 100 with a first orientation where the upper surface of the insulating housing 6 is facing up, for transmitting first signals. Conversely, the cable-end connector 200 is inserted into the board-end connector 100 with a second orientation where the upper surface of the insulating housing 6 is facing down, for transmitting second signals. Furthermore, the specification for transmitting the first signals is conformed to the specification for transmitting the second signals. It is noted that, the inserting orientation of the cable-end connector 200 is not limited by the board-end connector 100.

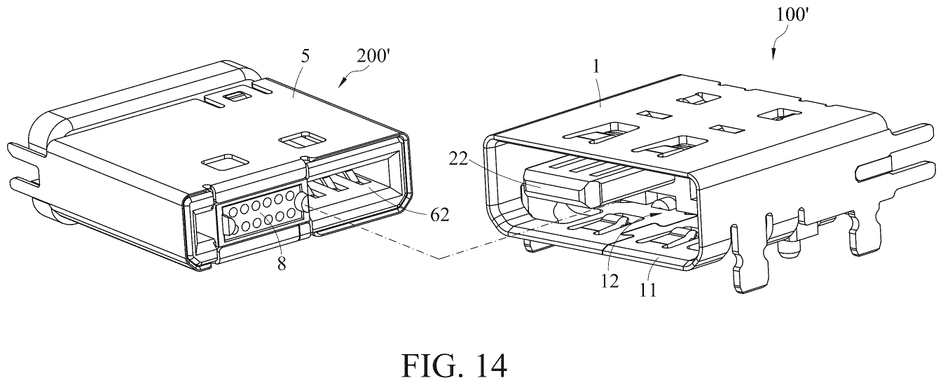

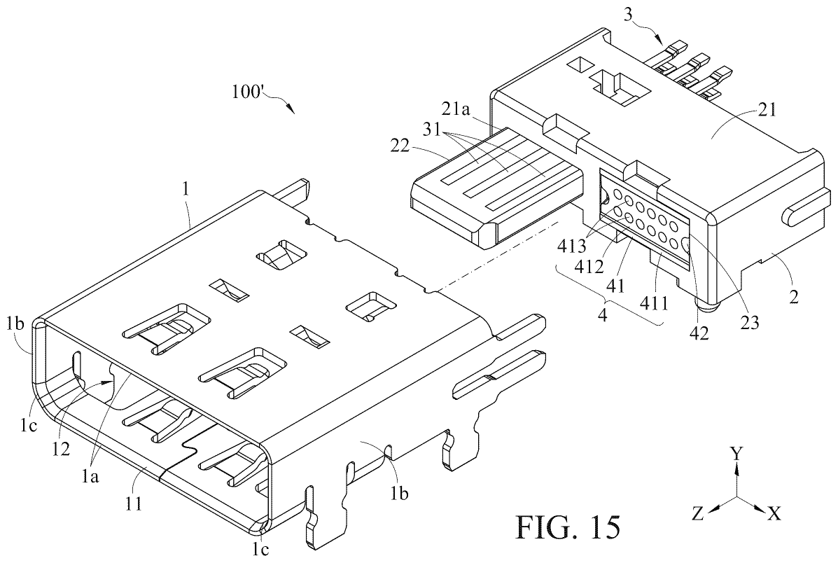

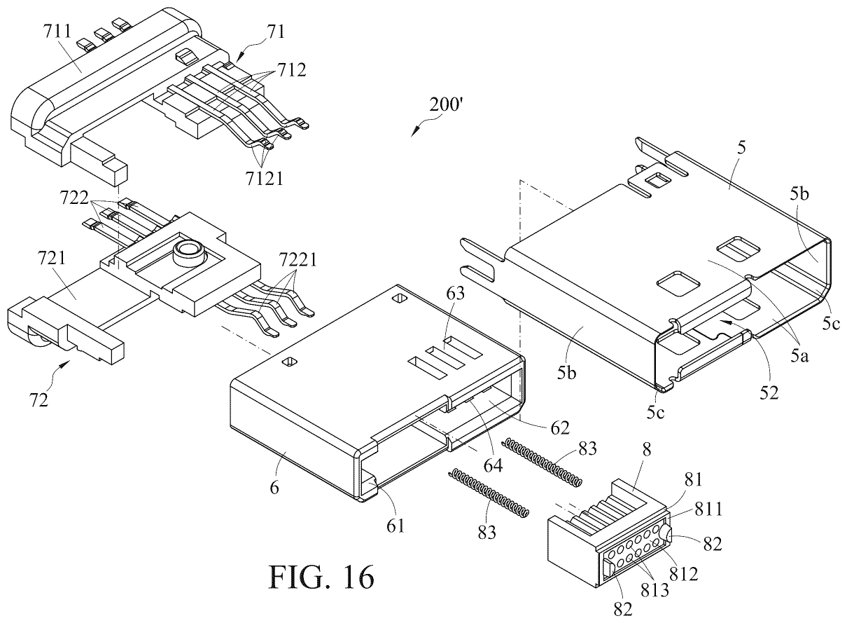

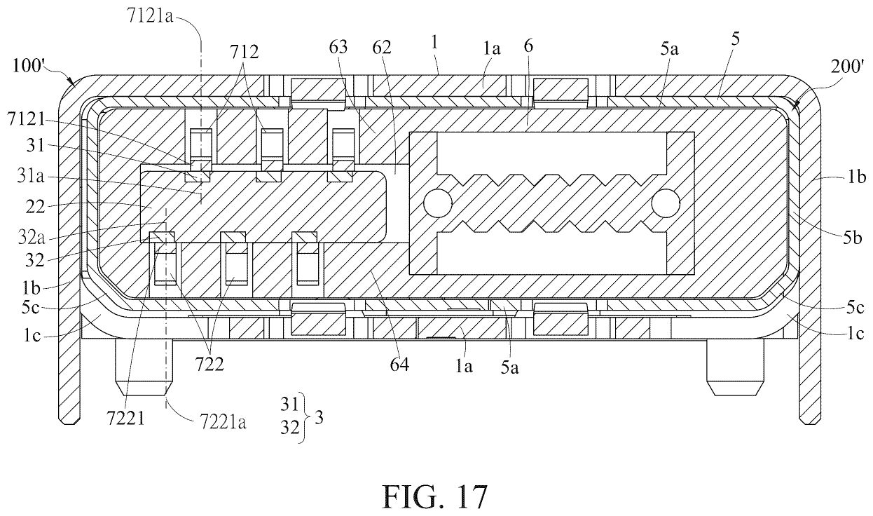

Please refer to FIG. 14 to FIG. 17. FIG. 14 illustrates a perspective view of a board-end connector 100′ and a cable-end connector 200′ of an optical-fiber connector assembly. FIG. 15 illustrates an exploded view of the board-end connector 100′ taken from an oblique top-plan view. FIG. 16 illustrates an exploded view of the board-end connector 100′ taken from an oblique bottom-plan view. FIG. 17 illustrates a cross-sectional view according to the viewing angle of FIG. 12. In some embodiments, the board-end connector 100′ comprises a tongue portion 22 extending from a side surface of the base portion 21. Viewing from the insertion opening 11 toward the accommodation space 12, the tongue portion 22 is at the left side of the accommodation space 12. The insulating housing 2 comprises an assembling portion 23 defined through the base portion 21 and adjacent to the tongue portion 22, and the assembling portion 23 is at the right side of the accommodation space 12.

Please refer to FIG. 14 to FIG. 17. In some embodiments, the receptacle power terminals 3 of the board-end connector 100′ comprise a plurality of first receptacle power terminals 3 (upper-row terminals) and a plurality of second receptacle power terminals 3 (lower-row terminals). The upper-row terminals are three flat terminals, the lower-row terminals are three flat terminals, and the number of the terminals may be six or more (e.g., eight or more). Moreover, the first receptacle power terminals 3 comprise three first-row flat contact portions 31 at one of the two faces of the tongue portion 22, and the second receptacle power terminals 3 comprise three second-row flat contact portions 32 at the other face of the tongue portion 22. Each of the first-row flat contact portions 31 defines a first axial line 31a extending from the other face of the tongue portion 22, and each of the second-row flat contact portions 32 defines a second axial line 32a extending from the one of the two faces of the tongue portion 22. Each of the first axial lines 31a is offset from a corresponding one of the second axial lines 32a, so that the upper terminals and the lower terminals are arranged in a staggered configuration. Therefore, one-time injection molding of the terminals can be achieved. Furthermore, the overall width of the tongue portion 22 may vary depending on the change of the number of the terminals; that is, in some embodiments, the greater the number of the terminals, the wider the overall width of the tongue portion 22.

Please refer to FIG. 14 to FIG. 17. In some embodiments, the insulating housing 6 of the cable-end connector 200′ comprises an insertion groove 62 between the first plate 63 and the second plate 64 and has a mating opening 61. The number of the insertion groove 62 is one. Viewing inward from the mating opening 61, the insertion groove 62 is at the right side of the mating opening 61, and the mating opening 61 is in communication with the insertion groove 62. The cable-end optical communication module 8 is at the mating opening 61 and at the side portion of the insertion groove 62.

Please refer to FIG. 14 to FIG. 17. In some embodiments, the first plug power terminals 712 of the cable-end connector 200′ comprise three first-row flexible contact portions 7121 at a side portion of the cable-end optical communication module 8, and the second plug power terminals 722 comprise three second-row flexible contact portions 7221 at the side portion of the cable-end optical communication module 8. The number of the first plug power terminals 712 and the second plug power terminals 722 may be six or more (e.g., eight or more). Moreover, each of the first-row flexible contact portions 7121 defines a first axial line 7121a extending toward the second plate 64, and each of the second-row flexible contact portions 7221 defines a second axial line 7221a extending toward the first plate 63. Each of the first axial lines 7121a is offset from a corresponding one of the second axial lines 7221a, so that the upper terminals and the lower terminals are arranged in a staggered configuration. Therefore, one-time injection molding of the terminals can be achieved. Moreover, the first axial line 7121a of the first-row flexible contact portion 7121 is aligned with the first axial line 31a of the first-row flat contact portion 31, and the second axial line 7221a of the second-row flexible contact portion 7221 is aligned with the second axial line 32a of the second-row flat contact portion 32. Furthermore, the overall width of the first plate 63 and the second plate 64 may vary depending on the change of the number of the terminals; that is, in some embodiments, the greater the number of the terminals, the wider the overall width of the first plate 63 and the second plate 64.

When the cable-end connector 200′ is mated with the board-end connector 100′, the cable-end shell 5 is inserted into the accommodation space 12 through the insertion opening 11 of the board-end shell 1, and the tongue portion 22 is inserted into the insertion groove 62, so that the cable-end connector 200′ and the board-end connector 100′ can be mated with each other. Next, the first-row flexible contact portions 7121 of the first plug power terminals 712 contact the first-row flat contact portions 31, and the second-row flexible contact portions 7221 of the second plug power terminals 722 contact the second-row flat contact portions 32. Then, the board-end optical communication module 4 is mated with the cable-end optical communication module 8, and signals can be transmitted through the optical-fiber wires connected to the board-end optical communication module 4 and the optical-fiber wires connected to the cable-end optical communication module 8.

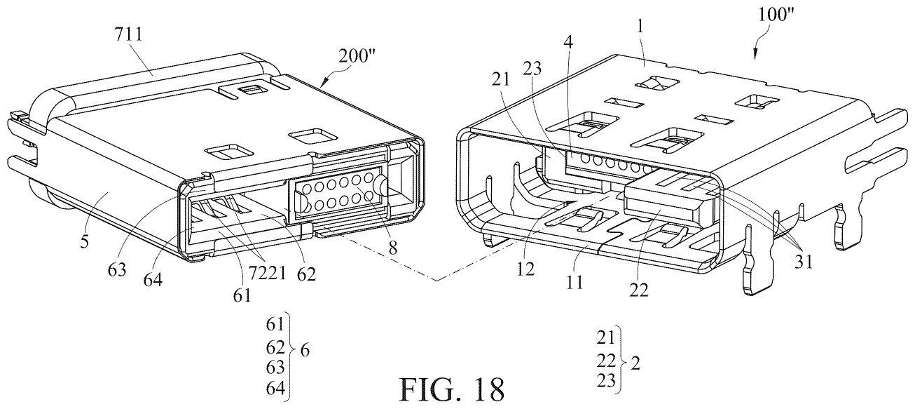

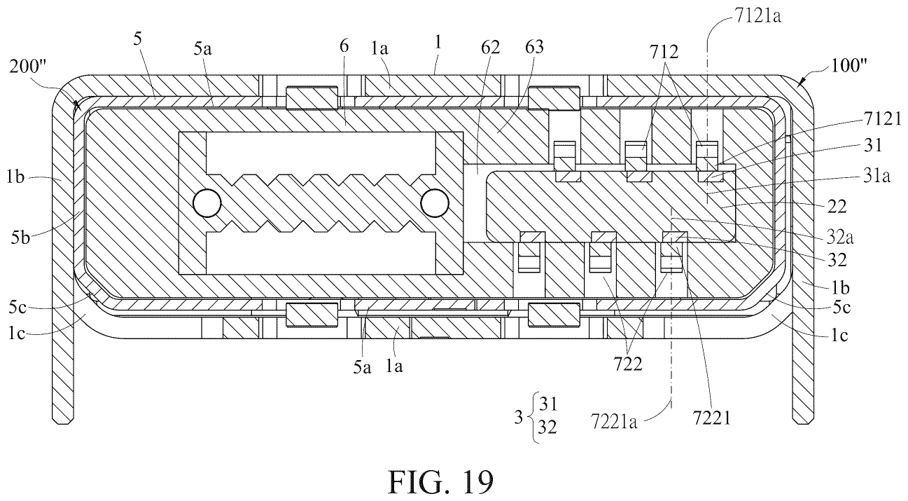

Please refer to FIG. 18 and FIG. 19. FIG. 18 illustrates a perspective view of a board-end connector 100″ and a cable-end connector 200″ of an optical-fiber connector assembly. FIG. 19 illustrates a cross-sectional view according to the viewing angle of FIG. 12. In some embodiments, the board-end connector 100″ comprises a tongue portion 22 extending from a side surface of the base portion 21. Viewing from the insertion opening 11 toward the accommodation space 12, the tongue portion 22 is at the right side of the accommodation space 12. The insulating housing 2 comprises an assembling portion 23 defined through the base portion 21 and adjacent to the tongue portion 22, and the assembling portion 23 is at the left side of the accommodation space 12. The detail structures of the board-end connector 100″ are similar to the detail structures of the board-end connector 100′ and thus related descriptions are omitted.

Please refer to FIG. 18 and FIG. 19. In some embodiments, the insulating housing 6 of the cable-end connector 200″ comprises an insertion groove 62 between the first plate 63 and the second plate 64 and has a mating opening 61. The number of the insertion groove 62 is one. Viewing inward from the mating opening 61, the insertion groove 62 is at the left side of the mating opening 61, and the mating opening 61 is in communication with the insertion groove 62. The cable-end optical communication module 8 is at the mating opening 61 and at the side portion of the insertion groove 62. The detail structures of the cable-end connector 200″ are similar to the detail structures of the cable-end connector 200′ and thus related descriptions are omitted.

As above, according to some embodiments, the insulating housing in the cable-end shell comprises the first plate and the second plate which are opposite to each other and the two insertion grooves between the first plate and the second plate, the first plug power terminals of the first terminal module and the second plug power terminals of the second terminal module base extend toward the insertion grooves from the first plate and the second plate. Therefore, the cable-end connector for an optical-fiber connector assembly can be provided. Moreover, the number of the plug power terminals of the cable-end connector can be adjusted according to different demands.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A cable-end connector of an optical-fiber connector assembly comprising:
a cable-end shell having an accommodation groove;
an insulating housing in the accommodation groove, wherein the insulating housing comprises a first plate and a second plate which are opposite to each other, two insertion grooves between the first plate and the second plate, and a mating opening in communication with the insertion grooves;
a first terminal module arranged at one of two ends of the insulating housing away from the mating opening, wherein the first terminal module comprises a first terminal base and a plurality of first plug power terminals retained in the first terminal base, and one of two ends of each of the first plug power terminals extends toward one of two sides of a corresponding one of the insertion grooves from the first plate;
a second terminal module arranged at the end of the insulating housing away from the mating opening, wherein the second terminal module comprises a second terminal base and a plurality of second plug power terminals retained in the second terminal base, one of two ends of each of the second plug power terminals extends toward the other side of the corresponding one of the insertion grooves from the second plate, and the second terminal base is assembled with the first terminal base; and
a cable-end optical communication module in the mating opening and between the insertion grooves.

2. The cable-end connector of the optical-fiber connector assembly according to claim 1, the first plug power terminals comprise a plurality of first-row flexible contact portions, the first-row flexible contact portions are at two sides of the cable-end optical communication module, the second plug power terminals comprise a plurality of second-row flexible contact portions, and the second-row flexible contact portions are at the two sides of the cable-end optical communication module; each of the first-row flexible contact portions defines a first axial line extending toward the second plate, each of the second-row flexible contact portions defines a second axial line extending toward the first plate, and each of the first axial lines is offset from a corresponding one of the second axial lines.

3. The cable-end connector of the optical-fiber connector assembly according to claim 2, wherein the number of the first plug power terminals on the first plate is four or more, the number of the second plug power terminals on the second plate is four or more, the first plug power terminals comprise four or more of the first-row flexible contact portions at the two sides of the cable-end optical communication module, and the second plug power terminals comprise four or more of the second-row flexible contact portions at the two sides of the cable-end optical communication module.

4. The cable-end connector of the optical-fiber connector assembly according to claim 1, wherein the cable-end shell has two long side walls opposite to each other and two short side walls opposite to each other, two sides of each of the short side walls are connected to the two long side walls, and a chamfer angle is at a corner between at least one of the short side walls and a corresponding one of the long side walls.

5. The cable-end connector of the optical-fiber connector assembly according to claim 1, wherein the cable-end optical communication module comprises a lens, and the lens has a mating surface facing the mating opening, a recessed portion at the mating surface, and a plurality of contacts in the recessed portion.

6. The cable-end connector of the optical-fiber connector assembly according to claim 5, wherein the number of the contacts is twelve or more, and the contacts are arranged as two rows.

7. The cable-end connector of the optical-fiber connector assembly according to claim 5, wherein the cable-end optical communication module comprises two guiding portions at the two sides of the mating surface and a plurality of elastic members at one of two ends of the lens away from the guiding portions, and two ends of each of the elastic members abut against the lens and the insulating housing.

8. A cable-end connector of the optical-fiber connector assembly comprising:
a cable-end shell having an accommodation groove;
an insulating housing in the accommodation groove, wherein the insulating housing comprises a first plate and a second plate which are opposite to each other, an insertion groove between the first plate and the second plate, and a mating opening in communication with the insertion groove;
a first terminal module arranged at one of two ends of the insulating housing away from the mating opening, wherein the first terminal module comprises a first terminal base and a plurality of first plug power terminals retained in the first terminal base, and one of two ends of each of the first plug power terminals extends toward one of two sides of the insertion groove from the first plate;
a second terminal module arranged at the end of the insulating housing away from the mating opening, wherein the second terminal module comprises a second terminal base and a plurality of second plug power terminals retained in the second terminal base, one of two ends of each of the second plug power terminals extends toward the other side of the insertion groove from the second plate, and the second terminal base is assembled with the first terminal base; and
a cable-end optical communication module in the mating opening and at a side portion of the insertion groove.

9. The cable-end connector of the optical-fiber connector assembly according to claim 8, the first plug power terminals comprise a plurality of first-row flexible contact portions, the first-row flexible contact portions are at a side portion of the cable-end optical communication module, the second plug power terminals comprise a plurality of second-row flexible contact portions, and the second-row flexible contact portions are at the side portion of the cable-end optical communication module and adjacent to the first-row flexible contact portions; each of the first-row flexible contact portions defines a first axial line extending toward the second plate, each of the second-row flexible contact portions defines a second axial line extending toward the first plate, and each of the first axial lines is offset from a corresponding one of the second axial lines.

10. The cable-end connector of the optical-fiber connector assembly according to claim 8, wherein the number of the first plug power terminals on the first plate is three or more, the number of the second plug power terminals on the second plate is three or more, the first plug power terminals comprise three of the first-row flexible contact portions at the side portion of the cable-end optical communication module, and the second plug power terminals comprise three of the second-row flexible contact portions at the side portion of the cable-end optical communication module.
